(19) United States
(12) Patent Application Publication
(10) Pub. No.: US 2009/0165010 A1
(43) Pub. Date: Jun. 25, 2009

(54) Method and system for optimizing utilization of resources

(76) Inventor: Ranjit Poddar, Jaipur Rajasthan (IN)

Correspondence Address: William L. Botjer, PO Box 478, Center Moriches, NY, 11934, US

(21) Appl. No.: 12/004,903

(22) Filed: Dec. 21, 2007

(51) Int. Cl. G06F 9/00; G06F 3/048

(52) U.S. Cl. 718/104; 715/700

(57) ABSTRACT

A method, application tool and computer program product for the optimal utilization of the resources in an organization. The organization has various processes. Each process includes an allocated number of resources. However, with the variation in the workload in a process, there may be under- or over-utilization of resources. Therefore, cross-utilization of resources across the different processes may result in the optimal utilization of resources in the organization.

### FIELD OF INVENTION

The invention relates to the management of resources in an organization. More specifically, the invention relates to the optimal utilization of resources in the organization.

### BACKGROUND

Typically, an organization has processes that enable it to be functional. Most of these processes require staffing of resources. The organization can be a contact center, a leasing service, or any other kind of business unit. The resource can be a workforce, a utility item or a product.

In the organization, each of the processes has an allocated workload. In accordance with the allocated workload, there is an average requirement of resources in a process. However, the actual workload in the process varies on a daily, weekly or monthly basis. For example, let us assume that in an organization, a process has been allocated four resources to complete the allocated work within a definite time frame of 60 days. Assuming that each of the resources works for a maximum time period of 10 hours per day, the four resources will be able to complete 2400 hours of the allocated work in 60 days. If, however, the actual work available for 60 days consumes only 1440 hours, due to some change in planning, then each of the resources would need to work for only 6 hours per day. In this case, the resources would be under-utilized for that period of time. In the event 3600 hours of actual work needs to be completed in 60 days, each resource would have to work for 15 hours per day. This would result in over-utilization of the resources in the process. Therefore, utilization of resources may change, based on the actual workload.

Under-utilization of resources results in the reduced productivity of a process. Similarly, over-utilization of resources results in a reduction in the efficiency of the resources, to deliver quality work in the process. Since there can be multiple processes that are utilized in an organization, the cumulative effect of imbalances in the utilization of resources results in an overall reduction in the Return on Investment (ROI) of the firm. Additionally, under-utilization or over-utilization of resources creates dissatisfaction among resources constituting the workforce. This dissatisfaction reduces the efficiency and productivity of the workforce.

Therefore, a need exists for a method and system for cross utilization of resources in an organization. This cross utilization of resources should combine the resources of two or more processes in an optimal manner. The optimal combination of the resources results in a reduction in the under-utilization or over-utilization of the resources in the two or more processes running individually. Moreover, there is a need for optimal utilization of resources, to reduce dissatisfaction among the workforce.

### SUMMARY

An object of the invention is to provide a method for the optimal utilization of resources in an organization.

Another object of the invention is to provide various strategies for the optimal cross-utilization of resources among the multiple processes in an organization.

Yet another object of the invention is to provide a Graphical User Interface (GUI) that is easy to operate and user friendly.

Various embodiments of the invention provide a method, a system and a computer program product for the optimal utilization of resources in an organization. The organization has multiple processes that require resources to execute the processes. In order to optimize utilization of the resources, a user inputs various parameters on a GUI. These parameters correspond to information pertaining to the processes. The GUI is linked to a processing engine, which retrieves series of values from a database, on the basis of the parameters received by the GUI. Each of the series of values corresponds to work-related information relating to the resources of each of the processes. Further, the database contains multiple series of values. Thereafter, the processing engine generates combined series by combining two or more of the series of values. Additionally, the processing engine calculates the statistical variance of the retrieved series of values and the combined series. Further, the processing engine generates various strategies on the basis of the statistical variance. These strategies are presented to the user through the GUI.

### BRIEF DESCRIPTION OF THE DRAWINGS

The preferred embodiments of the invention will hereinafter be described in conjunction with the appended drawings, provided to illustrate and not to limit the invention, wherein like designations denote like elements, and in which:

FIG. 1 depicts an environment in which various embodiments of the invention may be practiced;

FIG. 2 is a block diagram of the various elements of an application tool, in accordance with an embodiment of the invention;

FIG. 3 is a flowchart of a method for the optimal utilization of the resources in an organization, in accordance with an embodiment of the invention;

FIG. 4 is a flowchart of a method for adding new series of values to new processes, in accordance with an embodiment of the invention;

FIG. 5a illustrates an input screen of a Graphical User Interface (GUI), in accordance with an embodiment of the invention;

FIG. 5b illustrates the input screen, illustrating the selection of the location of the processes on the location-select element of the input screen, in accordance with an embodiment of the invention;

FIG. 6a illustrates an output screen of the Graphical User Interface (GUI), in accordance with an embodiment of the invention; and

FIG. 6b illustrates the output screen of the GUI, illustrating an other-best combination table depicting various strategies, in accordance with an embodiment of the invention.

### DESCRIPTION OF THE PREFERRED EMBODIMENTS

Various embodiments of the invention provide a method, system and computer program product for the optimal utilization of the resources in an organization.

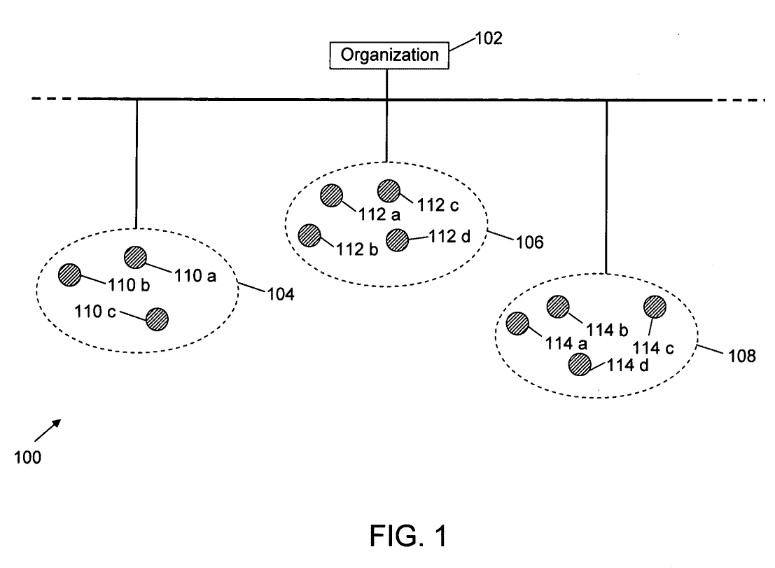

FIG. 1 depicts an environment 100 in which various embodiments of the invention may be practiced. Environment 100 includes an organization 102. Examples of organization 102 include a contact center, a service business, a manufacturing unit, and the like. Organization 102 includes processes 104, 106 and 108 that are executed in organization 102. Examples of processes 104, 106 and 108 in an organization 102 involved in the service business include application inputs, document generation, pre-audits, booking and funding, collections, cash applications, customer services, and the like. Each of the processes 104, 106 and 108 requires resources 110, 112 and 114, respectively, to complete the allocated work. In accordance with an embodiment of the invention, resources 110,112 and 114 can be human resources. Additionally, resources 110, 112 and 114 may need to have process-specific expertise or knowledge to complete the allocated work. For example, resources 110, 112 and 114, working in the contact center, need to have a good voice, effective communication skills, knowledge of basic finance, and the like, to execute processes 104, 106 and 108. The actual workload in organization 102 can vary on a daily, weekly or monthly basis. As a result, the requirement for resources 110, 112 and 114 can change, corresponding to the change in the workload. This results in the under- or over-utilization of resources 110, 112 and 114.

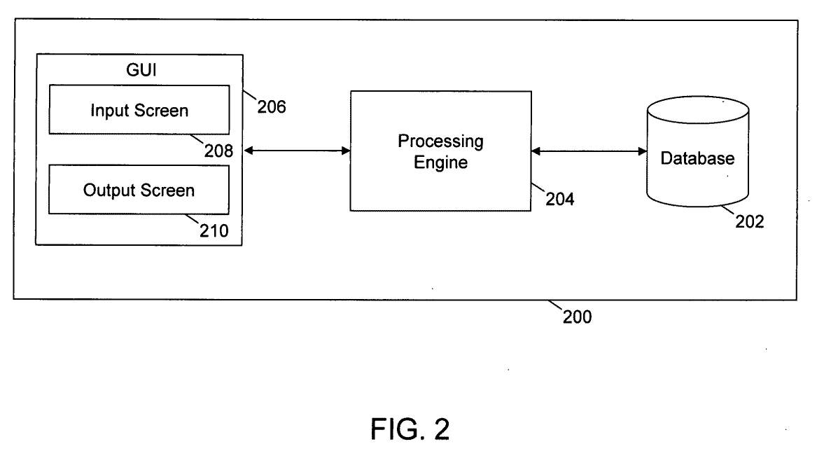

FIG. 2 is a block diagram of various elements of an application tool 200, in accordance with an embodiment of the invention. Application tool 200 includes a database 202, a processing engine 204, and a Graphical User Interface (GUI) 206. Database 202 includes various series of values corresponding to the utilization of resources 110,112 and 114 in processes 104, 106 and 108, respectively. Examples of database 202 include Microsoft Access™, Microsoft Excel™, Oracle™, and the like. In an embodiment of the invention, each of the series of values includes the number of resources 110, 112 and 114 required to carry out processes 104, 106 and 108 on a daily basis. The series are based on historical data for a pre-defined time period. In an embodiment of the invention, the pre-defined period is three months. For example, for a particular day in the month of September, database 202 includes data for the actual number of resources 110, 112 and 114 that were required for processes 104, 106 and 5108, respectively, on a daily basis over the months of May, June and July of the same year.

Additionally, database 202 includes various parameters corresponding to processes 104, 106 and 108. Examples of the parameters include the location and operational details of processes 104, 106 and 108. For example, the location of process 104 can be stored as New York, process 106 as Maryland, and process 108 as California. Database 202 includes information pertaining to the skill sets and shift timings of resources 110, 112 and 114. A skill set includes the specific skills required to operate processes 104, 106 or 108. Examples of such skills include a good voice, effective communication skills, knowledge of basic finance, language, and the like. Examples of shift timings can be 12:30-1830 hours or some other time period during the day in organization 102.

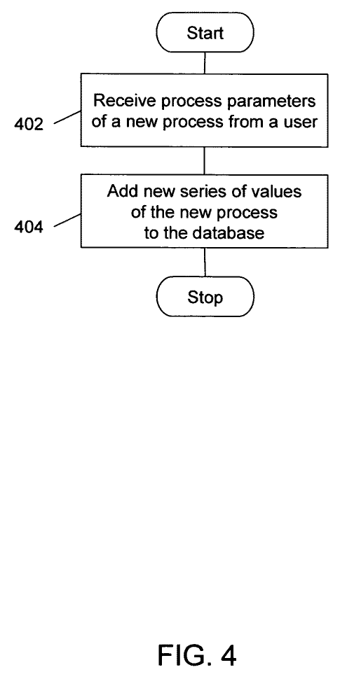

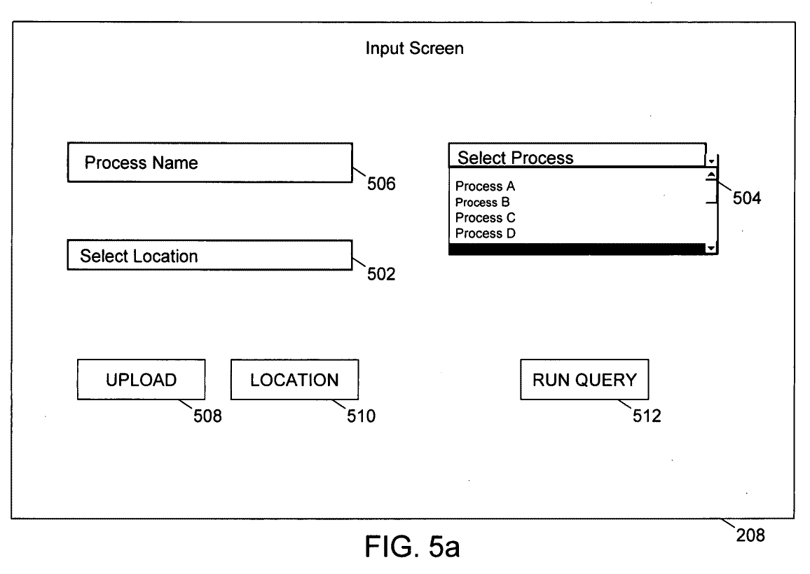

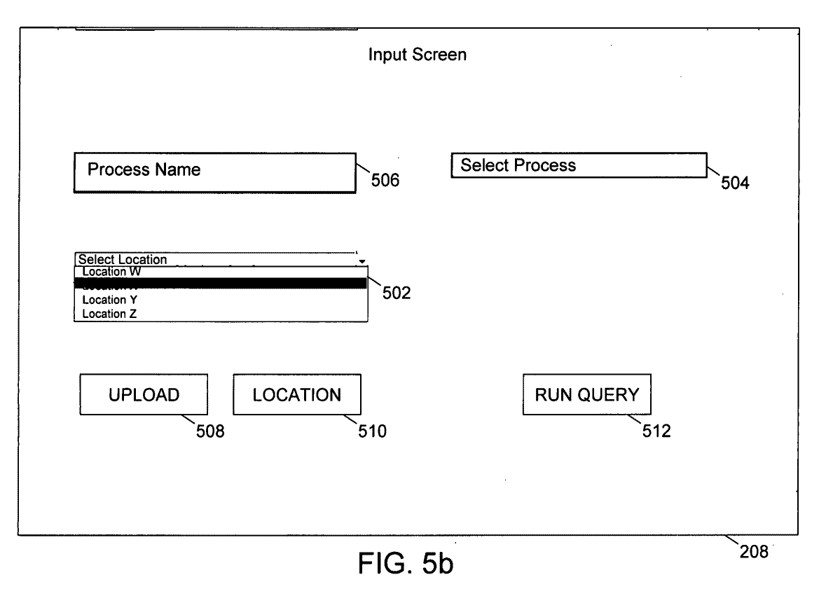

GUI 206 is an interface between a user and database 202 and includes an input screen 208 and an output screen 210. Input screen 208 enables the user of application tool 200 to select various parameters corresponding to processes 104, 106 or 108. Input screen 208 includes elements that enable it to input parameters, update series of values, and upload new series of values and processes. Output screen 210 presents various strategies to the user to utilize resources 110, 112 and 114. In an embodiment of the invention, these strategies are presented in the form of a list. In an embodiment of the invention, a graph, showing the utilization of resources 110, 112 and 114 on a daily basis for a pre-determined time period, is depicted on output screen 210. GUI 206 aids the user to select strategies that enable optimal utilization of resources 110, 112 and 114. Input screen 208 and output screen 210 are explained in detail in conjunction with FIG. 4a, FIG. 4b, FIG. 5a and FIG. 5b.

Processing engine 204 processes the series of values stored in database 202. These series of values are processed, based on the parameters received from the user on GUI 206. Processing involves the generation of multiple combined series from the series of values retrieved from database 202. These combined series are generated by combining two or more of the retrieved series of values, based on the user's selection of parameters. For example, if the user chooses to combine two series of values for processes 104, 106 and 108, these series of values are combined by selecting two processes at a time. As a result, three different combined series are generated. The three different combined series include a combination of process 104 and process 106, a combination of process 106 and process 108, and a combination of process 108 and process 104. Similarly, a combined series can be generated by combining the series of the values of processes 104, 106 and 108. In an embodiment of the invention, the combined series are generated by adding the corresponding values in the series of values of two or more processes 104 106, and 108. Additionally, processing engine 204 calculates the statistical variance of each of the retrieved series. This statistical variance facilitates the generation of a resource variation. Further, processing engine 204 calculates the statistical variance of each of the combined series. The statistical variance of the combined series generates combined resource variation. Processing engine 204 uses various mathematical and statistical formulas to combine and calculate the statistical variance of the series of values. Processing engine 204 generates various strategies for the utilization of resources 110, 112 and 114, based on the resource variation and the combined resource variation.

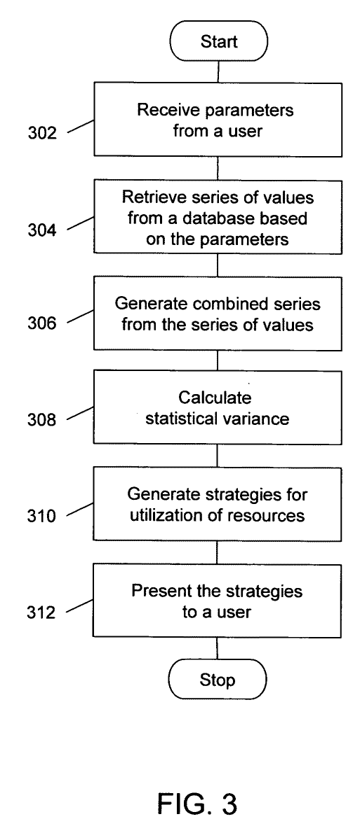

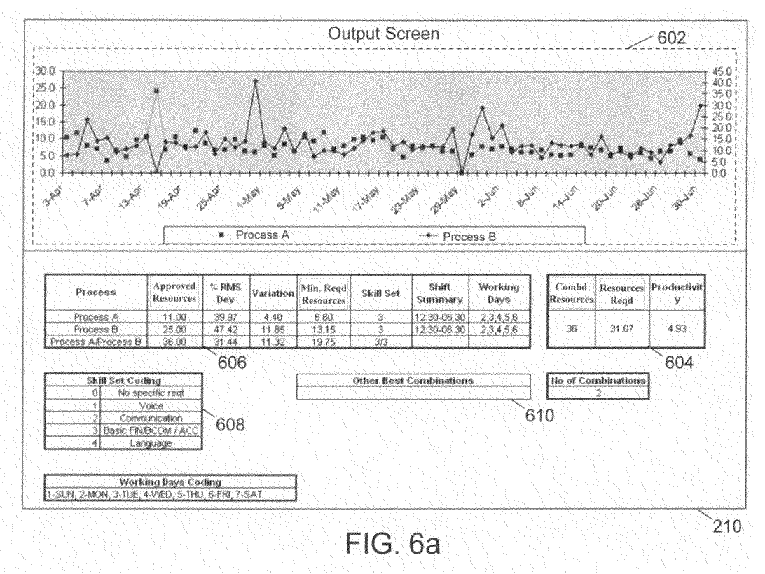

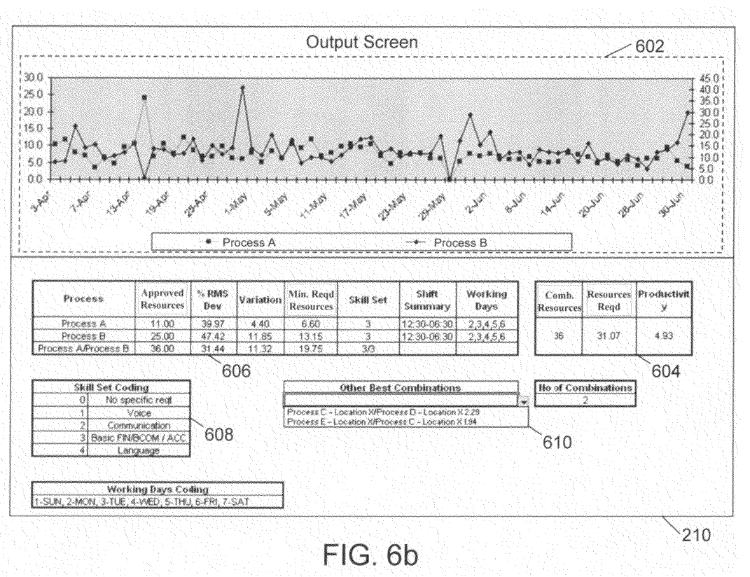

FIG. 3 is a flowchart of a method for the optimal utilization of the resources in an organization, in accordance with an embodiment of the invention. The flowchart of FIG.3 will hereinafter be explained in conjunction with FIGS. 1 and 2. At step 302, various parameters of processes 104, 106 and 108 are received from a user on input screen 208. Thereafter, at step 304, multiple series of values are retrieved from database 202, based on the parameters provided by a user. Subsequently, at step 306, multiple combined series are generated by processing engine 204, based on various combinations of the series of values. In an embodiment of the invention, a combined series is generated by adding the corresponding values in the series of values of two or more processes 104, 106 and 108. At step 308, a statistical variance is calculated for each of the series of values retrieved from database 202. The statistical variance is an indicator of the utilization of resources in processes 104, 106 and 108. In an embodiment of the invention, the statistical variance is calculated by calculating the Root Mean Square (RMS) deviation of the series of values retrieved from database 202. Additionally, at step 308, the statistical variance is calculated for each of the combined series, to generate a combined resource variation. Thereafter, at step 310, various strategies for the utilization of resources 110, 112 and 114 are generated, based on the resource variations and the combined resource variations. Each strategy is defined as a productivity value that is obtained by calculating the difference between the combined utilization of resources 110, 112 and 114 of two or more processes 104, 106 and 108, and the individual utilization of resources 110, 112 and 114 of two or more processes 104, 106 and 108. The generation of exemplary strategies has been explained in detail in conjunction with FIGS. 6a and 6b. Subsequently, at step 312, the generated strategies are presented to the user through GUI 206.

FIG. 4 illustrates a flowchart of a method for adding a new series of values for a new process in database 202, in accordance with an embodiment of the invention. The flowchart of FIG.4 will hereinafter be explained in conjunction with FIGS. 1 and 2. At step 402, the parameters of a new process are received on input screen 208 from a user. Thereafter, at step 404, the new series of values of the new process are added in database 202. In an embodiment of the invention, the new series of values are added manually by a user.

In an embodiment of the invention, the series of values in database 202 are updated when the latest values are available. In an embodiment of the invention, the series of values in database 202 are updated at regular intervals of time, which can be a week, a month or a number of months.

FIG. 5a illustrates an input screen 208 of GUI 206, in accordance with an embodiment of the invention. Input screen 208 includes a location select element 502, a process select element 504, a process input element 506, an upload button 508, a location button 510, and a run query button 512. Location select element 502 enables a user to select the location of operation of processes 104, 106 and 108. Process select element 504 displays processes 104, 106 and 108 operating at the location selected by the user. In an embodiment of the invention, process select element 504 displays a list of the processes executed in the organization at the location specified by the user. In an embodiment of the invention, the user can select two or more of processes 104, 106 and 108 listed in process select element 504. In another embodiment of the invention, the user can select the number of series that need to be combined from a list of the number of series that can be combined.

In an embodiment of the invention, input screen 208 facilitates the addition of a new series of values of a new process in database 202. Location select element 502 and process input element 506 receive the process parameters of the new process from the user.

FIG. 5b illustrates an input screen 208, depicting the selection of the location of the processes on location select element 502, in accordance with an embodiment of the invention. A user selects one of the locations of operation of processes 104, 106 and 108. Process select element 504 displays various processes 104, 106 and 108, based on the location selected by the user.

FIG. 6a illustrates an output screen 210 of GUI 206, in accordance with an embodiment of the invention. Output screen 210 includes a graph 602, a result table 604, a process table 606, a skill set code table 608, and an other-best combinations table 610. Graph 602 depicts a graphical representation of the variation of the daily utilization of resources 110, 112 and 114 over a pre-determined period of time. Process table 606 is a textual representation of the results of the calculations performed by processing engine 204. Result table 604 is a textual representation of the results of the calculations performed on the basis of data provided in process table 606. Skill set code table 608 is a textual representation of the various attributes of resources 110, 112 and 114. These attributes represent the various skills required to execute processes 104, 106 and 108.

Graph 602 depicts the daily variation in the utilization of resources 110, 112 and 114 for exemplary processes A and B. Process table 606 represents the results of the calculations performed by the processing engine 204 on the series of values. The ‘Approved Resources’ column in process table 606 depicts the number of resources 110, 112 and 114 allocated for the process A. The ‘% RMS Dev’ column depicts the RMS deviation of the series of values of process A. On the basis of the values of the allocated number of resources 110, 112 and 114, and the RMS deviation for process A, a resource variation value is calculated and shown as 4.40 in the ‘Variation’ column. The variation in resources 110, 112 and 114 is subtracted from the allocated number of resources 110, 112 and 114, and the minimum required number of resources 110, 112, and 114 is shown as 6.60 in the ‘Min. Reqd Resources’ column.

Additionally, the row corresponding to process A provides information about the skills required by the resources 110, 112 and 114, the shift timings of resources 110, 112 and 114 and their working days. Similarly, second row of process table 606 represents the calculations required for process B. The series of values of processes A and B are combined, resulting in a combined process ‘Process A/Process B’, as shown in the ‘Process’ column. In the combined process, the resource variation is 11.32, as shown in the ‘Variation’ column. Calculating the combined aggregate of the combined process resource variations (11.32) and the aggregate of the minimum required resources of Processes A and B, i.e., 4.40 and 11.85, respectively, provides the actual resources required. Result table 604 provides an estimate of the actual number of resources required, on the basis of the values shown in process table 606, i.e., 31.07, as shown in the ‘Resources Reqd’ column. The allocated number of resources in processes A and B are combined to obtain the combined number of resources. The combined number of resources is calculated as 36, as shown in the ‘Combined Resources’ column. Therefore, the productivity value of 4.93 is calculated, based on the difference between the combined number of resources, i.e., 36, and the actual resources required, i.e., 31.07. This enables the formulation of a strategy for utilizing the resources in processes A and B of organization 102. In an embodiment of the invention, various strategies can be generated by using the various combinations of processes 104, 106 and 108.

FIG. 6b illustrates an output screen 210 depicting other best combinations table 610, in accordance with an embodiment of the invention. Other best combinations table 610 presents a list of strategies depicting the productivity values of combinations of processes 104, 106 and 108 to the user. The list of strategies is generated by processing engine 204, based on the parameters entered by the user on input screen 208.

Various embodiments of the invention provide a method for the optimal utilization of the resources in an organization. The method provides the organization with a simple methodology to utilize resources across various processes in the firm.

Various embodiments of the invention provide a list of strategies for optimal cross-utilization of resources among the various processes in an organization.

Various embodiments of the invention provide a GUI that is easy to operate because of the elements present in the interface. Additionally, the GUI is user friendly, since even a person without any prior knowledge can operate it.

The application tool, as described in the invention or any of its components, may be embodied in the form of a computer system. Typical examples of a computer system include a general-purpose computer, a programmed microprocessor, a micro-controller, a peripheral integrated circuit element, and other devices or arrangements of devices that are capable of implementing the steps that constitute the method of the invention.

The computer system comprises a computer, an input device, a display unit and the Internet. The computer comprises a microprocessor, which is connected to a communication bus. The computer also includes a memory, which may include Random Access Memory (RAM) and Read Only Memory (ROM). The computer system comprises a storage device, which can be a hard disk drive or a removable storage drive such as a floppy disk drive, an optical disk drive, and the like. The storage device can also be other similar means for loading computer programs or other instructions into the computer system.

While the preferred embodiments of the invention have been illustrated and described, it will be clear that the invention is not limited to these embodiments only. Numerous modifications, changes, variations, substitutions and equivalents will be apparent to those skilled in the art, without departing from the spirit and scope of the invention, as described in the claims.

What is claimed is:

1. A method for optimal utilization of resources in an organization, wherein the resources are required for executing a plurality of processes in the organization, the method comprising the steps of:
(a) receiving a plurality of parameters from a user;
(b) retrieving series of values from a database based on the plurality of parameters, wherein each of the series of values corresponds to one of the plurality of processes;
(c) generating a plurality of combined series, wherein each of the plurality of combined series is generated by combining two or more of the series of values; and
(d) processing the series of values and the plurality of combined series to generate a plurality of strategies for utilization of the resources.

2. The method of claim 1, wherein the step of processing the series of values and the plurality of combined series comprises the steps of:
(a) calculating a statistical variance for each of the series of values; and
(b) calculating a resource variation based on the statistical variance for each of the series of values.

3. The method of claim 2 further comprising the steps of:
(a) calculating the statistical variance for each of the plurality of combined series; and
(b) calculating a combined resource variation based on the statistical variance for each of the plurality of combined series.

4. The method of claim 1 further comprising the step of displaying the plurality of strategies on a Graphical User Interface (GUI).

5. The method of claim 1, wherein the plurality of parameters are received from the user through a GUI.

6. The method of claim 1 further comprising the step of updating the series of values in the database.

7. The method of claim 1 further comprising the step of adding new series of values in the database, wherein the new series of values correspond to new processes.

8. The method of claim 7 further comprising the steps of:
(a) receiving process parameters for atleast one of the new processes from the user; and
(b) adding the new series of values in the database based on the process parameters, the new series of values correspond to the atleast one of the new processes.

9. The method of claim 1, wherein one of the plurality of parameters comprises the location of the plurality of processes.

10. The method of claim 1, wherein a parameter comprises a count of the plurality of processes to be combined.

11. The method of claim 1, wherein the series of values are based on historical data, the historical data corresponding to information regarding the resources.

12. The method of claim 11, wherein the historical data is considered for a pre-defined time period.

13. A method for optimal utilization of resources in an organization, wherein the resources are required for executing a plurality of processes in the organization, the method comprising the steps of:
(a) receiving a plurality of parameters from a user through a Graphical User Interface (GUI);
(b) retrieving series of values from a database based on the plurality of parameters, wherein each of the series of values corresponds to one of the plurality of processes;
(c) generating a plurality of combined series, wherein each of the plurality of combined series is generated by combining two or more of the series of values;
(d) calculating a statistical variance for each of the series of values and for each of the plurality of combined series;
(e) calculating a resource variation based on the statistical variance;
(f) generating a plurality of strategies based on the resource variation; and
(g) presenting the plurality of strategies on the GUI.

14. An application tool for optimal utilization of resources in an organization, wherein the resources are required for executing a plurality of processes, the application tool comprises:
(a) a database for storing series of values, wherein each of the series of values corresponds to one of the plurality of processes;
(b) a Graphical User Interface (GUI) for receiving a plurality of parameters from a user, the plurality of parameters are required to retrieve a plurality of the series of values from the database; and
(c) a processing engine for processing the plurality of the series of values to generate a plurality of strategies for utilization of the resources.

15. The application tool of claim 14, wherein the processing engine calculates a statistical variance for each of the plurality of the series of values.

16. The application tool of claim 14, wherein the processing engine generates a plurality of combined series, the plurality of combined series is generated by combining a plurality of the series of values.

17. The application tool of claim 16, wherein the processing engine further calculates a statistical variance for each of the plurality of combined series.

18. The application tool of claim 14, wherein the GUI comprises an input screen for receiving the plurality of parameters from the user.

19. The application tool of claim 18, wherein the input screen comprises atleast one graphical element for selecting the plurality of parameters.

20. The application tool of claim 14, wherein the GUI comprises an output screen for presenting the plurality of strategies to the user.

21. The application tool of claim 20, wherein the output screen displays textual data.

22. The application tool of claim 20, wherein the output screen displays graphical data.

23. The application tool of claim 20, wherein the output screen displays the plurality of strategies.

24. A computer program product for optimal utilization of resources in an organization for use with a computer, the computer program product comprising a computer usable medium having a computer readable program code embodied therein, wherein the resources are required for executing a plurality of processes, the computer program product including computer readable instructions for performing the steps of:
(a) receiving a plurality of parameters from a user;
(b) retrieving series of values from a database based on the plurality of parameters, wherein each of the series of values corresponds to one of the plurality of processes;
(c) generating a plurality of combined series, wherein each of the plurality of combined series is generated by combining two or more of the series of values; and
(d) processing the series of values and the plurality of combined series to generate a plurality of strategies for utilization of the resources.
